(19) United States
(12) Patent Application Publication
(10) Pub. No.: US 2023/0214727 A1
(43) Pub. Date: Jul. 6, 2023

(54) Degradation Estimation Device and Degradation Estimation Method

(71) Applicant: Nippon Telegraph and Telephone Corporation, Tokyo (JP)

(72) Inventors: Masahiro Sotoma, Musashino-shi, Tokyo (JP); Masayuki Tsuda, Musashino-shi, Tokyo (JP)

(21) Appl. No.: 18/000,565

(22) PCT Filed: Jun. 5, 2020
(86) PCT No.: PCT/JP2020/022367

§ 371 Date: Dec. 2, 2022

(51) Int. Cl. G06N 20/20

(52) U.S. Cl. CPC G06N 20/20

(57) ABSTRACT

A deterioration estimation device of the present embodiment is provided with a machine learning unit, a stacking function unit and a GWS calculation unit. The machine learning unit estimates deterioration indices respectively using a plurality of estimation models in a first layer created by performing different types of machine learning using environment information and facility information of dispersedly installed facilities as explanatory variables and the deterioration indices as objective variables. The GWS calculation unit calculates geographically weighted statistics of the deterioration indices. The machine learning unit estimates geographically weighted statistics of the deterioration indices using a statistic estimation model created by performing machine learning using the environment information and the facility information of the dispersedly installed facilities as explanatory variables and the geographically weighted statistics of the deterioration indices as objective variables. The stacking function unit estimates deterioration indices from estimation results of the estimation models in the first layer and an estimation result of geographic statistics.

### TECHNICAL FIELD

The present invention relates to a deterioration estimation device and a deterioration estimation method.

### BACKGROUND ART

In order to maintain functions of aging infrastructure facilities, it is important to estimate deterioration of the facilities. In particular, the degree of deterioration of the facilities installed outdoors in a dispersed manner (hereinafter described as “dispersedly installed facilities”), such as road facilities, electric facilities and communication facilities, varies depending on an installation environment. For this reason, it is often difficult to estimate the deterioration simply by years of use.

In improving accuracy of deterioration estimation of the dispersedly installed facilities, an expression of a relationship between the installation environment and the deterioration is crucial. In many cases, a relationship between environment elements (e.g., temperature, humidity) and some indices representing the deterioration is functionalized and deterioration estimation is performed based on it.

### CITATION LIST

### Non-Patent Literature

Non-Patent Literature 1: Isabella Gollini, et al., “GWmodel: An R Package for Exploring Spatial Heterogeneity Using Geographically Weighted Models”, Journal of Statistical Software, January 2015, Volume 63, Issue 17.

### SUMMARY OF THE INVENTION

### Technical Problem

The technologies focusing on the relationship between the installation environment and the deterioration can be said to be based on an idea that facilities based on a combination of similar environments will cause similar deterioration. This idea is based on a spatial statistical concept in the geography field whether consciously or unconsciously. The spatial statistics can be said to be an idea that there is a certain relationship between a thing and its spatial positioning or that a relationship between things can be described as a relationship between spaces to which the things belong, for example, and the spatial statistical concept is considered important in improving the accuracy of deterioration estimation of the dispersedly installed facilities.

However, while there are conventional technologies regarding deterioration estimation of dispersedly installed facilities based on a relational expression between environmental elements such as meteorology and certain indices representing a degree of deterioration, there is no technology that explicitly utilizes spatial statistical concepts.

The present invention has been implemented in view of the above-described circumstances, and it is an object of the present invention to more accurately estimate a degree of deterioration of dispersedly installed facilities.

### Means for Solving the Problem

A deterioration estimation device according to an aspect of the present invention includes a first machine learning unit that estimates deterioration indices respectively using a plurality of estimation models in a first layer created by performing different types of machine learning using environment information and facility information of dispersedly installed facilities as explanatory variables and the deterioration indices as objective variables, a calculation unit that calculates geographically weighted statistics of the deterioration indices, a second machine learning unit that estimates geographically weighted statistics of the deterioration indices using a statistic estimation model created by performing machine learning using the environment information and the facility information of the dispersedly installed facilities as explanatory variables and the geographically weighted statistics of the deterioration indices as objective variables, and a stacking function unit that estimates deterioration indices from estimation results of the plurality of estimation models in the first layer and an estimation result of the geographic statistics, using an estimation model in a second layer created by performing machine learning with estimation results of the statistic estimation model added as explanatory variables and estimation results of the plurality of estimation models in the first layer as input.

A deterioration estimation method according to another aspect of the present invention is a deterioration estimation method implemented by a computer, the method including estimating deterioration indices respectively using a plurality of estimation models in a first layer created by performing different types of machine learning using environment information and facility information of dispersedly installed facilities as explanatory variables and the deterioration indices as objective variables, calculating geographically weighted statistics of the deterioration indices, estimating geographically weighted statistics of the deterioration indices using a statistic estimation model created by performing machine learning using the environment information and the facility information of the dispersedly installed facilities as explanatory variables and the geographically weighted statistics of the deterioration indices as objective variables, and estimating deterioration indices from estimation results of the plurality of estimation models in the first layer and an estimation result of the geographic statistics, using an estimation model in a second layer created by performing machine learning with estimation results of the statistic estimation model added as explanatory variables and estimation results of the plurality of estimation models in the first layer as input.

### Effects of the Invention

According to the present invention, it is possible to more accurately estimate the degree of deterioration of dispersedly installed facilities.

### BRIEF DESCRIPTION OF DRAWINGS

FIG. 1 is a diagram illustrating an example of configuration of a deterioration estimation device according to the present embodiment.

FIG. 2 is a diagram illustrating an example of information stored in a database.

FIG. 3 is a diagram illustrating an example of geographically weighted statistics and estimates thereof.

FIG. 4 is a diagram illustrating an example of a deterioration index estimation structure.

FIG. 5 is a diagram illustrating another example of the deterioration index estimation structure.

FIG. 6 is a diagram illustrating a further example of the deterioration index estimation structure.

FIG. 7 is a flowchart illustrating a processing flow for estimating deterioration indices.

### DESCRIPTION OF EMBODIMENTS

Hereinafter, embodiments of the present invention will be described with reference to the accompanying drawings.

In the present embodiment, a communication utility pole (hereinafter described as a “utility pole”) will be described as an example of a dispersedly installed facility as a deterioration estimation target. However, the deterioration estimation target is not limited to the utility pole, but the present invention is also applicable to various dispersedly installed facilities.

Installation positions of utility poles are assumed to be determinable by position information on, for example, latitude and longitude coordinates. It is assumed that specifications of the utility poles (hereinafter described as “facility information”) are recorded or can be acquired as required.

It is assumed that indices representing a deterioration situation of each utility pole (hereinafter described as “deterioration indices”) obtained by past inspections of several utility poles are recorded. It is assumed that deterioration indices at the latest inspection of at least several utility poles are known. The deterioration indices may be in any format like continuous values, discrete values or class values.

It is assumed that environment information representing an installation environment of utility poles including past data is recorded or can be acquired or created as required. The environment information is, for example, atmospheric temperature, humidity, amount of insolation and population density, and is considered to affect deterioration of utility poles.

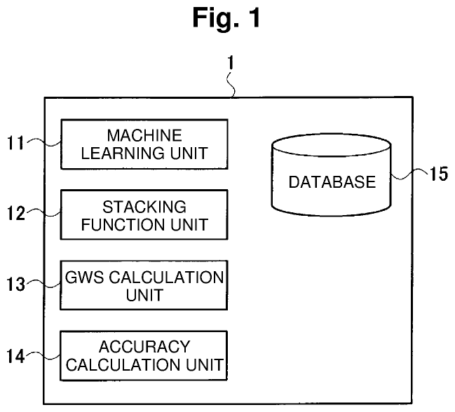

A configuration example of the deterioration estimation device according to the present embodiment will be described with reference to FIG. 1. A deterioration estimation device 1 shown in FIG. 1 is provided with a machine learning unit 11, a stacking function unit 12, a GWS calculation unit 13, an accuracy calculation unit 14 and a database 15. Each unit of the deterioration estimation device 1 may be constructed of a computer equipped with a calculation processing device, a storage device or the like and processing of each unit may be executed by a program. This program is stored in the storage device of the deterioration estimation device 1 and can be recorded in a recording medium such as a magnetic disk, an optical disk or a semiconductor memory or can also be provided via a network.

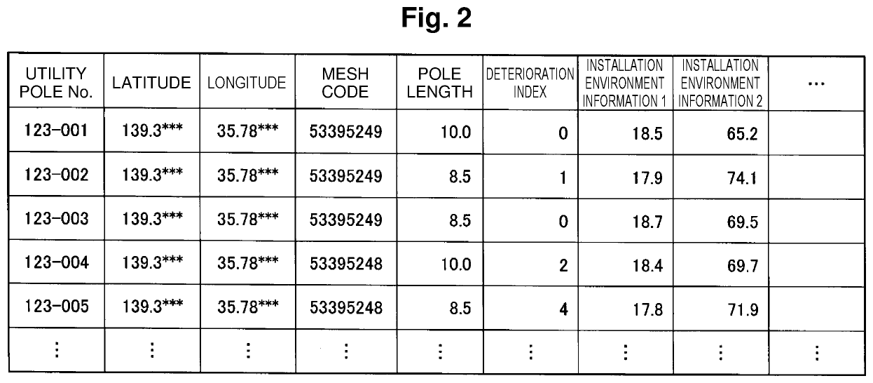

The database 15 stores position information, facility information, deterioration indices and environment information for each utility pole. FIG. 2 illustrates an example of information stored in the database 15. In the example in FIG. 2, latitude, longitude and mesh code, which is position information, pole length, which is facility information, deterioration index and installation environment information 1 and 2 are stored in association with a utility pole number that identifies each utility pole. In the present embodiment, inspection results recorded in five deterioration ranks from rank 1 to rank 5 depending on a deterioration state are used as deterioration indices. Rank 1 means a worst condition. Such information can be associated on the basis of position information. The database 15 can store information generated in a process of calculation or can be handled integrally. The information stored in the database 15 can be displayed as required. The information may be visualized on a map using a geographic information system (GIS).

The machine learning unit 11 obtains a plurality of estimation models that estimate deterioration indices through machine learning using a plurality of techniques using environment information and facility information as explanatory variables, and the deterioration indices as objective variables. In the present embodiment, five different machine learning techniques are used and the five machine learning techniques are described as ML1 to ML5.

The GWS calculation unit 13 calculates geographically weighted statistics (GWS) of deterioration indices. In addition to understanding a relationship between an environment element and a single utility pole deterioration index, understanding a relationship between an environment element and spatial statistics of deterioration indices between a plurality of adjacent utility poles makes it possible to describe a complicated relationship that may exist between the environment elements or between an environment element and a deterioration index, using the environment element. The spatial statistics makes it possible to perform analysis in consideration of a spatial relationship between things. In the present embodiment, an improvement of estimation accuracy of deterioration indices is achieved by using GWS among various indices belonging to spatial statistics and obtaining a model to estimate the GWS of the deterioration indices with environment elements. Note that any index belonging to or similar to the spatial statistics is also applicable as an index other than the GWS.

Although there are several types of GWS, two types of GWS: a geographically weighted mean and a geographically weighted standard deviation are used in the present embodiment. Conventional techniques can be used as GWS calculation methods. A calculation expression for the geographically weighted mean is shown below as an example.

$$m ( {z}_{i} ) = \frac{{\sum }_{j = 1}^{n} {w}_{ij} {z}_{j}}{{\sum }_{j = 1}^{n} {w}_{ij}} \qquad Math . 1$$

A term m(zᵢ) is a geographically weighted mean of an attribute value “z” at a point “i” located at a position (uᵢ, vᵢ). A term wᵢⱼ is a weight at a point “j” with respect to the point “i.” Although there are a plurality of methods to calculate “wᵢⱼ,” a calculation expression according to a Gaussian method will be illustrated as an example here.

$${w}_{ij} = exp ( - \frac{1}{2} {( \frac{{d}_{ij}}{b} )}^{2} ) \qquad Math . 2$$

A term “dᵢⱼ” is a distance between the point “i” and the point “j.” A term “b” is a bandwidth that defines a range to calculate the GWS.

In the present embodiment, a deterioration rank, which is a deterioration index of a utility pole is assigned to an attribute value “z.” Examples of a method of setting the bandwidth “b” include a method of defining a certain range with respect to mainly the utility pole at the point “i” and a method of defining the number of other utility poles located adjacent to the utility pole at the point “i.”

The latter method is adopted and two types: 5 adjacent poles and 30 adjacent poles are set in the present embodiment.

The machine learning unit 11 creates an estimation model to estimate a GWS of deterioration indices through machine learning using a plurality of techniques using the GWS of deterioration indices calculated by the GWS calculation unit 13 and using environment information and facility information as explanatory variables, and the GWS of deterioration indices as objective variables. The estimation model of the GWS may also be created using the same plurality of techniques as the techniques used for the estimation model of deterioration indices. The estimation model of the GWS corresponding to the most accurate technique is adopted and added as a new explanatory variable in a second layer of the stacking configuration to estimate deterioration indices.

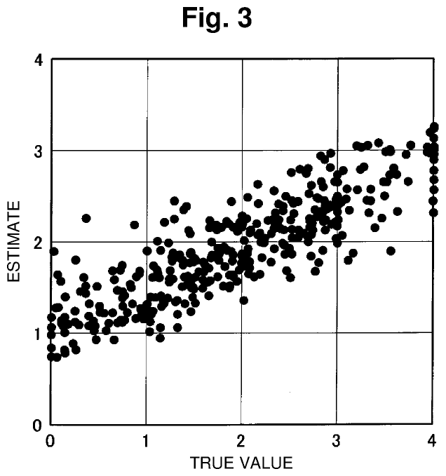

FIG. 3 illustrates a plot of true values of geographically weighted mean and estimates from an estimation model created by the machine learning unit 11. The GWS is not a discrete value such as a deterioration rank but a continuous value, and so GWS estimation is a regression analysis, not a classification analysis.

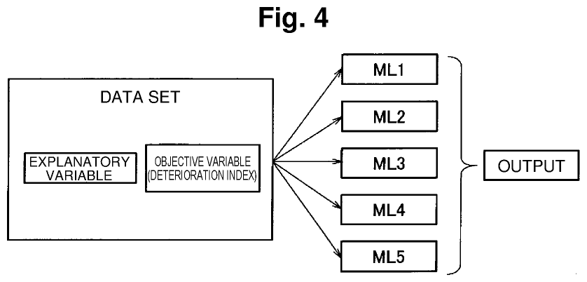

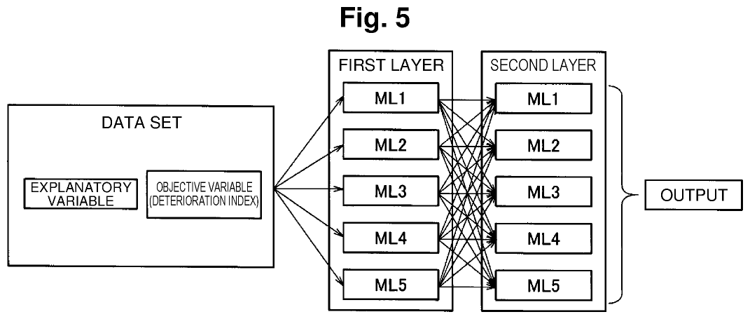

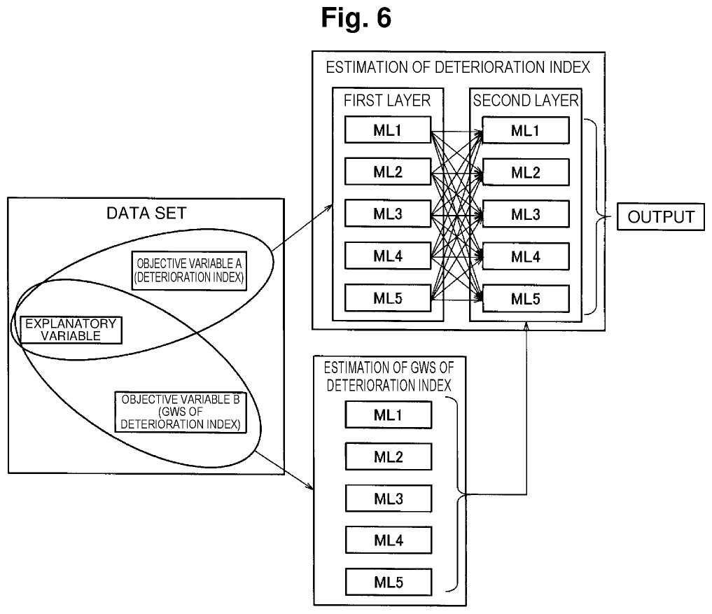

The stacking function unit 12 performs stacking using a plurality of machine learning results in the machine learning unit 11 as input for the next stage, and thus performs learning and estimation in a multi-stage configuration. The stacking in the machine learning field performs learning or the like using a plurality of machine learning results over again, and is one of techniques for improving accuracy and generalization performance. An estimation structure used in the present embodiment is illustrated in FIGS. 4 to 6. FIG. 5 and FIG. 6 illustrate estimation structures using stacking.

In the estimation structure 1 in FIG. 4, an objective variable is a deterioration index and five different machine learning techniques are tried. The result of the technique with the highest estimation accuracy will be adopted as a final estimate.

An estimation structure 2 in FIG. 5 is a stacking structure where objective variables are deterioration indices and results of five different machine learning techniques in a first layer are used and subjected to the five different machine learning techniques in a second layer. The result of the technique with the highest estimation accuracy in the second layer is adopted as the final estimate.

In an estimation structure 3 in FIG. 6, GWS of deterioration indices is calculated from the same data set as that in FIG. 4 and FIG. 5, and the GWS of deterioration indices is handled as an objective variable. A deterioration index is assumed to be an objective variable A and GWS of deterioration indices is assumed to be an objective variable B. The objective variable A and the objective variable B are estimated using five different machine learning techniques. The result of the technique with the highest estimation accuracy for the objective variable B is adopted and added to the second layer of the estimation flow of the objective variable A as a new explanatory variable. The result of the technique with the highest estimation accuracy in the second layer is adopted as the final estimate.

Note that in the estimation structure 2 in FIG. 5 and the estimation structure 3 in FIG. 6, the machine learning technique in the second layer and the machine learning technique used for GWS estimation of deterioration indices do not have to be the same as the first layer, it can be one.

The accuracy calculation unit 14 calculates estimation accuracy of each technique and determines an estimate based on evaluation criteria. The evaluation criteria include what index should be used as an index for estimation accuracy. The accuracy calculation unit 14 may determine estimates based on, for example, a threshold set for each index or may adopt estimates using the technique with the highest estimation accuracy.

There are a variety of indices representing estimation accuracy, and f1-score and Recall are used in the present embodiment.

The f1-score is calculated from a harmonic mean of detection accuracy (Precision) and a detection rate (Recall), and can be said to represent overall estimation accuracy. The f1-score is represented by a numerical value between 0 and 1, meaning that the closer it is to 1, the better the accuracy.

The Recall is an index which is often used when there is a classification target to be handled with priority. When a deterioration condition is estimated to revise dispersedly installed facilities, it is preferable to be able to correctly estimate a rank (e.g., rank 1 and rank 2) meaning that the deterioration condition is worse. In general, it is often the case that a classification to be handled with priority is called “positive” and other classifications are called “negative.” In the present embodiment, rank 1 or 2 corresponds to positive and ranks 3 to 5 correspond to negative. The Recall is also represented by a numerical value between 0 and 1, which means that the closer it is to 1, the better the accuracy.

Table 1 shows an example of estimation accuracy of machine learning ML1 to ML5 in the estimation structure 1 in FIG. 4, Table 2 shows an example of estimation accuracy of machine learning ML1 to ML5 of the second layer of the estimation structure 2 in FIG. 5, and Table 3 shows an example of estimation accuracy of machine learning ML1 to ML5 of the second layer in the estimation structure 3 in FIG. 6.

TABLE 1

| | ML1 | ML2 | ML3 | ML4 | ML5 |
|---|---|---|---|---|---|
| f1-score | 0.32 | 0.30 | 0.30 | 0.33 | 0.36 |
| Recall | 0.50 | 0.47 | 0.58 | 0.49 | 0.48 |

TABLE 2

| | ML1 | ML2 | ML3 | ML4 | ML5 |
|---|---|---|---|---|---|
| f1-score | 0.29 | 0.29 | 0.32 | 0.28 | 0.33 |
| Recall | 0.54 | 0.62 | 0.53 | 0.54 | 0.54 |

TABLE 3

| | ML1 | ML2 | ML3 | ML4 | ML5 |
|---|---|---|---|---|---|
| f1-score | 0.44 | 0.47 | 0.36 | 0.51 | 0.53 |
| Recall | 0.79 | 0.64 | 0.62 | 0.78 | 0.74 |

When a comparison is made in estimation accuracy between the estimation structures, if the f1-score is used as an index for estimation accuracy, it is known that estimation accuracy of ML5 of the estimation structure 3 is highest. On the other hand, if the Recall focusing on estimating a rank of low deterioration condition is used as an index for estimation accuracy, it is known that the estimation structure of ML1 of the estimation structure 3 is the best. In this way, it is possible to obtain an estimation model that suits the purpose and an estimate thereof.

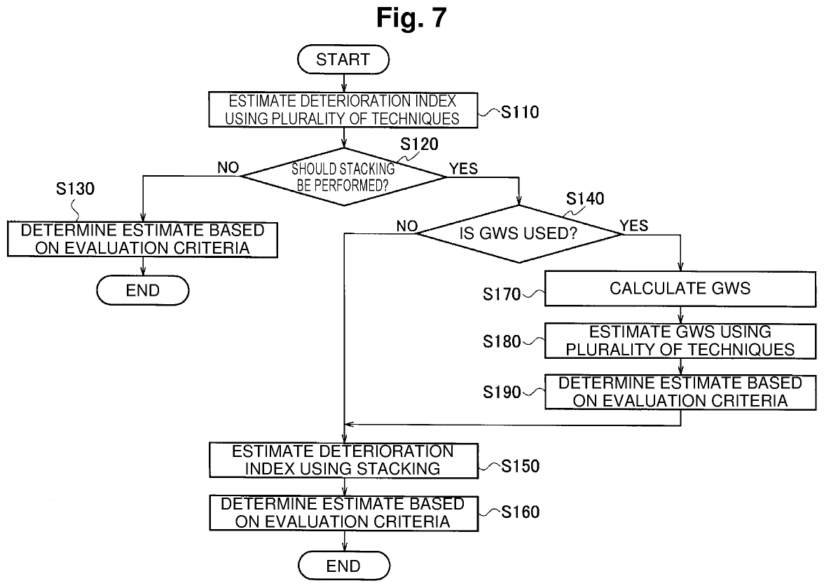

Next, a processing flow for estimating a deterioration index by the deterioration estimation device of the present embodiment will be described with reference to FIG. 7.

In step S110, the machine learning unit 11 estimates a deterioration index using a plurality of techniques. The process in step S110 corresponds to the ML1 to ML5 in the estimation structure 1 estimating the deterioration index or ML1 to ML5 in the first layer in the estimation structure 2 or the estimation structure 3 estimating the deterioration index. As the data processing method and the calculation expression necessary for the technique, the data recorded in advance in the database 15 may be used or may be set every time by the system operator. Moreover, the technique may be automatically selected according to conditions recorded in advance in the database 15 or may be selected by the system operator every time. The same applies to the following processes.

In step S120, the stacking function unit 12 determines whether or not to use stacking of machine learning. This determination may be made according to the conditions recorded in advance in the database 15 or may be made by the system operator every time.

When no stacking is used, the accuracy calculation unit 14 calculates estimation accuracy of each technique in step S130 and determines estimates based on the evaluation criteria. The processes up to this point correspond to the estimation process of the deterioration index using the estimation structure 1.

When stacking is used, the stacking function unit 12 determines whether or not to use the GWS of deterioration indices for deterioration estimation in step S140. This determination may be made according to the condition recorded in advance in the database 15 or may be made by the system operator every time.

When the GWS of deterioration indices is not used, in step S150, the stacking function unit 12 applies stacking to the estimation result in step S110 and estimates the deterioration indices using a plurality of techniques. The process in step S150 here corresponds to the ML1 to ML5 in the first layer of the estimation structure 2 inputting the estimation results and the ML1 to ML5 in the second layer estimating the deterioration indices.

In step S160, the accuracy calculation unit 14 calculates estimation accuracy of each technique and determines the estimates based on the evaluation criteria. The processes up to this point correspond to the estimation process of the deterioration indices using the estimation structure 2.

When the GWS of deterioration indices is used, the GWS calculation unit 13 calculates the GWS of deterioration indices in step S170.

In step S180, the machine learning unit 11 estimates the GWS of deterioration indices according to a plurality of techniques using the GWS of deterioration indices obtained in step S180 as a true value. The process in step S180 corresponds to ML1 to ML5 in the estimation structure 3 estimating the GWS of deterioration indices.

In step S190, the accuracy calculation unit 14 calculates estimation accuracy of each technique and the stacking function unit 12 determines the estimation result to be added as an explanatory variable based on the evaluation criteria.

After that, in step S150, the stacking function unit 12 adds the estimation result of the GWS of deterioration indices as explanatory variables, applies stacking to the estimation result in step S110 and estimates the deterioration indices using a plurality of techniques. The process in step S150 here corresponds to adding the estimation results of the GWS of deterioration indices in the estimation structure 3 as explanatory variables, inputting the estimation results of ML1 to ML5 in the first layer and ML1 to ML5 in the second layer estimating the deterioration index.

In step S160, the accuracy calculation unit 14 calculates estimation accuracy of each technique and determines estimates based on the evaluation criteria. The processes up to this point correspond to the estimation process of the deterioration indices using the estimation structure 3.

As described above, a deterioration estimation device 1 of the present embodiment is provided with a machine learning unit 11, a stacking function unit 12 and a GWS calculation unit 13. The machine learning unit 11 estimates deterioration indices respectively using a plurality of estimation models in a first layer created by performing different types of machine learning using environment information and facility information of dispersedly installed facilities as explanatory variables and the deterioration indices as objective variables. The GWS calculation unit 13 calculates geographically weighted statistics of the deterioration indices. The machine learning unit 11 estimates geographically weighted statistics of the deterioration indices using a statistic estimation model created by performing machine learning using the environment information and the facility information of the dispersedly installed facilities as explanatory variables and the geographically weighted statistics of the deterioration indices as objective variables. The stacking function unit 12 estimates deterioration indices from estimation results of the plurality of estimation models in the first layer and an estimation result of geographic statistics, using an estimation model in a second layer created by performing machine learning with estimation results of the statistic estimation model added as explanatory variables and estimation results of the plurality of estimation models in the first layer as input. This makes it possible to more accurately estimate the degree of deterioration of the dispersedly installed facilities. As a result, it is possible to increase efficiency of maintenance and management of the facilities.

### REFERENCE SIGNS LIST

1 deterioration estimation device
11 machine learning unit
12 stacking function unit
13 GWS calculation unit
14 accuracy calculation unit
15 database

1. A deterioration estimation device comprising:
a first machine learning unit that estimates deterioration indices respectively using a plurality of estimation models in a first layer created by performing different types of machine learning using environment information and facility information of dispersedly installed facilities as explanatory variables and the deterioration indices as objective variables;
a calculation unit that calculates geographically weighted statistics of the deterioration indices;
a second machine learning unit that estimates geographically weighted statistics of the deterioration indices using a statistic estimation model created by performing machine learning using the environment information and the facility information of the dispersedly installed facilities as explanatory variables and the geographically weighted statistics of the deterioration indices as objective variables; and
a stacking function unit that estimates deterioration indices from estimation results of the plurality of estimation models in the first layer and an estimation result of the geographic statistics, using an estimation model in a second layer created by performing machine learning with estimation results of the statistic estimation model added as explanatory variables and estimation results of the plurality of estimation models in the first layer as input.

2. The deterioration estimation device according to claim 1, wherein
the stacking function unit estimates deterioration indices from the estimation results of the estimation models in the first layer using a plurality of estimation models in the second layer created by performing different types of machine learning with the estimation results of the statistic estimation model added as explanatory variables and the estimation results of the plurality of estimation models in the first layer as input, and
the deterioration estimation device comprises an accuracy calculation unit that calculates estimation accuracy of each of the plurality of estimation models in the second layer and adopts an estimation result of an estimation model with highest estimation accuracy.

3. The deterioration estimation device according to claim 1, wherein
the second machine learning unit estimates the geographically weighted statistics of the deterioration indices using a plurality of statistic estimation models created by performing different types of machine learning using the environment information and the facility information of the dispersedly installed facilities as explanatory variables and the geographically weighted statistics of the deterioration indices as objective variables, and
the stacking function unit adds an estimation result of a statistic estimation model with highest estimation accuracy as an explanatory variable.

4. A deterioration estimation method implemented by a computer, the method comprising:
estimating deterioration indices respectively using a plurality of estimation models in a first layer created by performing different types of machine learning using environment information and facility information of dispersedly installed facilities as explanatory variables and the deterioration indices as objective variables;
calculating geographically weighted statistics of the deterioration indices;
estimating geographically weighted statistics of the deterioration indices using a statistic estimation model created by performing machine learning using the environment information and the facility information of the dispersedly installed facilities as explanatory variables and the geographically weighted statistics of the deterioration indices as objective variables; and
estimating deterioration indices from estimation results of the plurality of estimation models in the first layer and an estimation result of the geographical statistics, using an estimation model in a second layer created by performing machine learning with estimation results of the statistic estimation model added as explanatory variables and estimation results of the plurality of estimation models in the first layer as input.

5. The deterioration estimation device according to claim 2, wherein
the second machine learning unit estimates the geographically weighted statistics of the deterioration indices using a plurality of statistic estimation models created by performing different types of machine learning using the environment information and the facility information of the dispersedly installed facilities as explanatory variables and the geographically weighted statistics of the deterioration indices as objective variables, and
the stacking function unit adds an estimation result of a statistic estimation model with highest estimation accuracy as an explanatory variable.
